(19) United States
(12) Patent Application Publication
(10) Pub. No.: US 2013/0042450 A1
(43) Pub. Date: Feb. 21, 2013

(54) Apparatus for joining two or more overlapping material members and method for manufacturing of the apparatus

(71) Applicant: Hans R. Bergkvist, Domdidier (CH)

(72) Inventor: Hans R. Bergkvist, Domdidier (CH)

(21) Appl. No.: 13/209,460

(22) Filed: Aug. 15, 2011

(51) Int. Cl. B23Q 1/00; B23P 11/00

(52) U.S. Cl. 29/283.5; 29/428

(57) ABSTRACT

A tool kit, primarily intended for clinching, consisting of a punch (3.1), surrounded by an elastic stripper (3.2), a die cavity (3.5) the bottom of which constitutes an anvil (3.6) and the sides of which consist of two or more moving die elements (3.7) and (3.8).

The moving die elements can slide laterally on a flat supporting face (3.9).

One or more guiding elements (3.11) running parallel to the supporting face have dimensions, cross-sections and axial positions that closely match through holes (3.12) in the die elements and thus make the die elements slide laterally on the supporting face, steered by the guiding elements. The guiding elements consequently prevent the die elements from pivoting or rotating and generate a pure sliding.

The length of each guiding element is roughly equal to or exceeds the distance between the outer faces of the die elements, even when the die elements are the furthest from an axis (3.10) running through punch and anvil, which will keep the die elements in place when the stripper pulls the punch out after the clinching operation finished.

A method by which the described die design can be manufactured in a simple and economical way.

### TECHNICAL FIELD

The invention concerns an apparatus for joining two or more overlapping material members and a method for manufacturing of the apparatus.

### BACKGROUND ART

The need to join two or more overlapping construction elements like sheet material and/or profiles in metal or other materials is present in virtually all industry segments, from the automotive sector to appliances, ventilation and the construction area.

Common methods for such joining is welding, in particular spot welding, but also assembly using added fasteners like screws, both classical and self-tapping, and rivets, both classical and pop-rivets.

During the later decenniums, mechanical joining methods have grown in importance. These methods include stitchfolding and above all clinching.

Clinching is a method based on cold flow deformation.

The principle is illustrated in FIG. 1a. A punch (1.1), most frequently surrounded by a spring acting element, a stripper (1.2), pushes parts of the overlapping material members, here illustrated by two (1.3) and (1.4), into a die cavity (1.5) the bottom of which forms an anvil (1.6) and the sides of which consist of two or more moving die elements, here shown as (1.7) and (1.8). When the material members further are pressed together between punch and anvil, FIG. 1b, parts of the material will flow laterally and thus force the moving die elements to move outwards with respect to an axis running through the punch and anvil.

When the axial forces vanish, the spring action of the stripper will pull out the punch from the cavity that has been formed from the overlapping material members. The final result is that the overlapping material members now have become mechanically locked together as shown in FIG. 2.

Many ways of realizing a die with moving die elements are known. Standing die elements in spring steel are shown among others by Eckold et al., EP0513473. A drawback of this solution is that the die elements have to be relatively long in order to allow the required bending and the axial height of the die consequently becomes considerable. Another drawback is that this design becomes extremely sensitive to deviations from that the axis through punch and anvil runs perpendicularly to the overlapping material members, as such an angular deviation will put so great forces on one of the die elements that it often will break.

Another way of realizing the intended mobility of the die elements is to allow them to pivot around axes, as shown by Sawdon, U.S. Pat. No. 5,150,513.

Letting the die elements rest on a supporting face and give them a convex shape that facilitates a pivoting movement is shown among others by Kynl U.S. Pat. No. 5,131,258 and Sawdon et al., U.S. Pat. No. 5,339,509.

Drawbacks with this type of pivoting movement is that the considerable axial forces present for clinching, typically 30-100 kN, will be transmitted over small areas, which means high contact pressures. These high contact pressures will affect the life time of such dies negatively.

An attempt to find solutions with a lateral sliding of the die elements on a more or less complex support surface is shown among others by Faivre U.S. Pat. No. 5,509,290. However, the intended sliding in reality most frequently turns out to be a pivoting, in particular when the geometry of the die elements does not favor pure sliding.

A problem that has to find a simple solution is to ensure that the moving die elements stay in place when the stripper pulls the punch out of the cavity created in the overlapping material members.

Faivre, U.S. Pat. No. 5,509,290, shows a complex solution with an outer, retaining cage.

Kuehne, US2007266759, shows another, equally complex solution, where the lateral sliding is promoted, but yet can not be fully guaranteed, by pins that run parallel to a supporting surface, through the die elements and through slots in a surrounding structure.

The drawbacks of these solutions are mainly related to the fact that the sliding can not be guaranteed and that the devices are highly complicated with a multitude of small components that have to be manufactured to tight tolerances and consequently become expensive.

### DISCLOSURE OF INVENTION

### Technical Solution

The present invention solves the problems apparent in the state-of-the-art as it has the characteristics reported in the subsequent patent claims. It also offers a simple and economical method for the manufacturing of the apparatus.

### DESCRIPTION OF DRAWINGS

FIGS. 1a. and 1b. show the principle of clinching

FIG. 2. shows a cut through a clinched joint

FIG. 3. shows a die design

FIG. 4. shows an alternate die design with a surrounding cage

FIG. 5. shows a die design with an integrated cage

FIG. 6. shows the first step in the manufacturing of the die

FIGS. 7a. and 7b. show subsequent steps in the manufacturing of the die

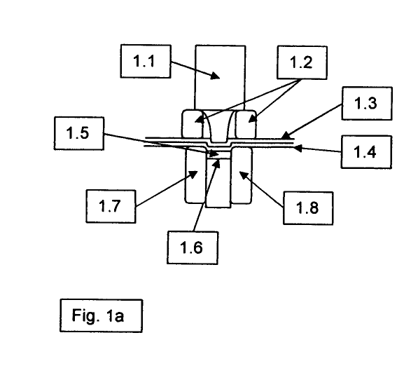

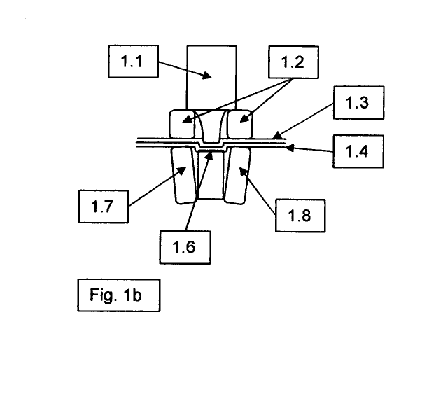

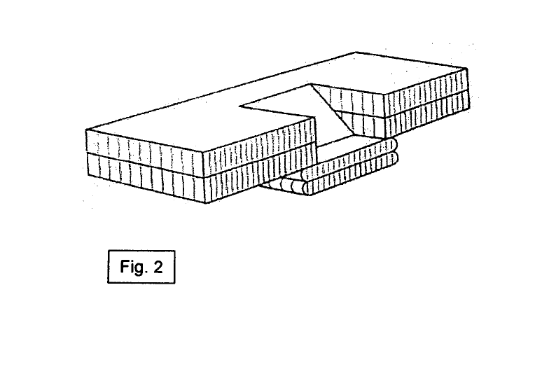

### MODE OF INVENTION

The invention offers a solution that meets the two main requirements of a die design.

Firstly the die elements shall move laterally, with respect to an axis running through punch and anvil, by sliding rather than by pivoting or rotating, on a robust supporting surface, running essentially perpendicularly to the axis through punch and anvil. As the die elements slide, the contact area between die element and supporting surface will be greater than if the die elements would pivot, which results in a lower contact pressure and thus an increased life time of the die.

Secondly, the die elements have to be prevented from being ripped out axially when the stripper pulls the punch out of the cavity created from the overlapping material members.

Furthermore it would be advantageous if such a die design could be realized in a simple and economic way.

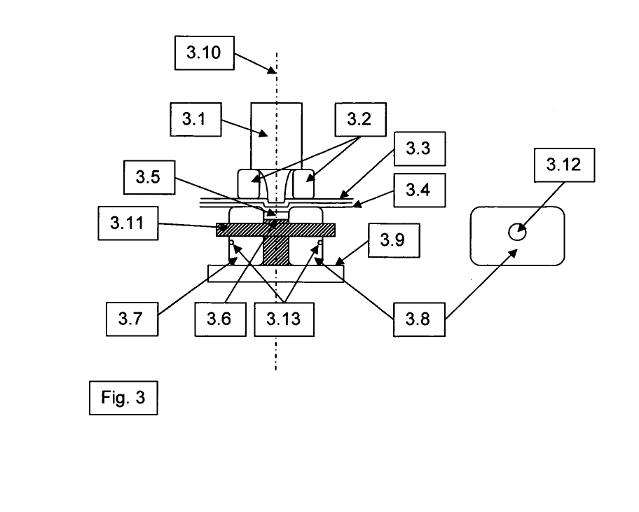

FIG. 3. shows such a solution, here illustrated by an example with one guiding element.

A punch (3.1), surrounded by an elastic stripper (3.2), pushes parts of the overlapping material members, here illustrated by two, (3.3) and (3.4), into a die cavity (3.5) the bottom of which is an anvil (3.6) and the sides of which consist of two or more moving die elements, here shown as (3.7) and 3.8).

The moving die elements can slide laterally i.e. on a smooth supporting surface (3.9) running essentially perpendicularly to an axis (3.10) through the punch and the center of the anvil.

Essentially perpendicularly to the anvil, and firmly connected thereto is one or more guiding elements (3.11) which consequently run parallel to the supporting surface.

Each guiding element has dimensions, cross section, surface finish and axial position that closely match through holes (3.12) in the die elements and that will make the die elements slide on the supporting surface, steered by the guiding elements. The guiding elements consequently prevent the die elements from pivoting or rotating and ensure a pure sliding. In the neutral position the die elements are pressed against the anvil through elastic elements (3.13) which can be one or more ring shaped springs.

The length of each guiding element is roughly equal to or exceeds the distance between the outer faces of the die elements, even when they are at maximum distance from the axis (3.10) through punch and anvil, which will ensure that the die elements remain in place axially when the stripper pulls out the punch after completion of the clinching operation.

In this way the invention fulfills the two key requirements.

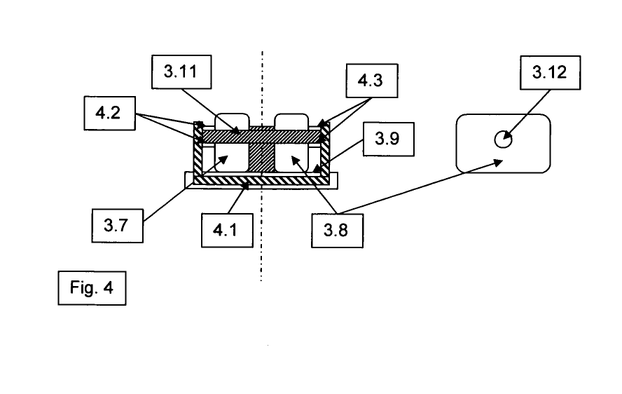

FIG. 4. shows an alternate solution of the invention, here illustrated by an example with one guiding element the extremities of which are held in a cage (4.1) connected to the other parts of the die and where the spring action (4.2) and (4.3) between the cage and the die elements replace the above mentioned ring shaped springs (3.13).

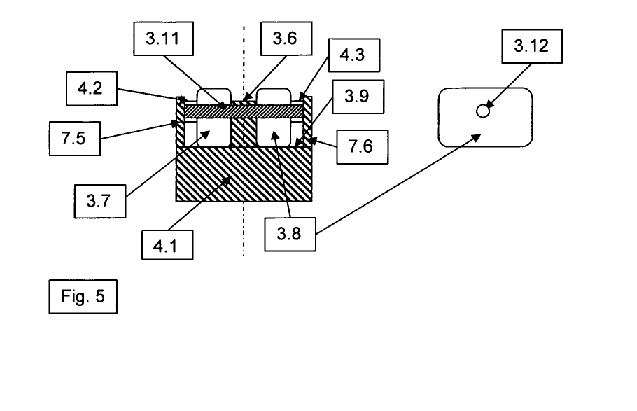

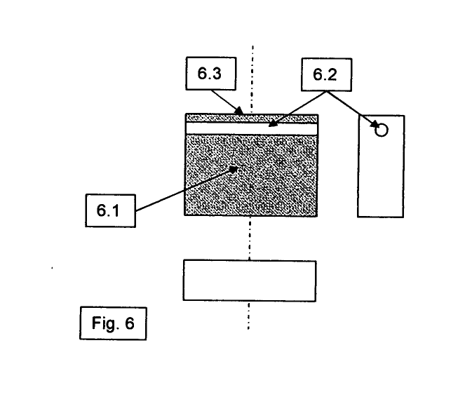

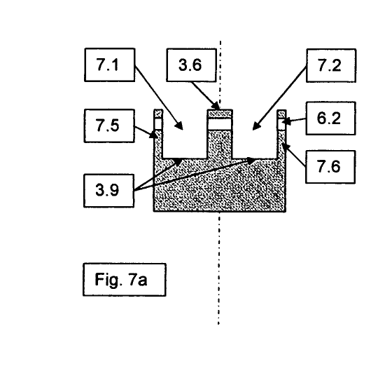

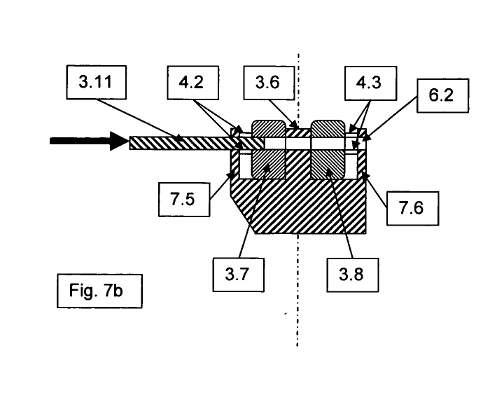

FIG. 5. shows still another solution of the invention where the cage forms an integrated part of the die body.

### INDUSTRIAL APPLICABILITY

The apparatus shown in FIG. 5. can be manufactured in a simple and economical way, here illustrated by an example with one guiding element.

A blank for the non-moving parts of the die having essentially the shape of a parallelepiped (6.1) is machined in such a way that a through hole (6.2) is created parallel to the upper rectangular face (6.3) of the blank (6.1) and oriented along the longer dimension of the upper rectangular face (6.3), whereafter grooves (7.1) and (7.2) are created perpendicularly to the through hole (6.2) in such a way that the anvil (3.6), the supporting surface (3.9) and the solid side parts (7.5) and (7.6) of the die to the intended dimensions, whereafter the blank (6.1) is given its final, not necessarily parallelepipedic shape, whereafter selected parts such as the anvil (3.6) and the supporting surface (3.9) is given appropriate hardness, whereafter final assembly can take place, whereas the guiding element (3.11) is pushed in place from one solid side part of the die (7.5), through the through hole (6.2), in such a way that the guiding element (3.11) runs though the spring element (4.2), the die element (3.7), the anvil (3.6), the die element (3.8), the spring element (4.3) and finally reaching the other solid side part of the die (7.6).

If the guiding element (3.11) and the through hole (6.2) in the anvil (3.6) have such tolerances that a shrink fit is created, no circlips or other locking rings will be necessary to hold the guiding element in place.

A close fit between the guiding element and the through hole in the anvil is also advantageous as the anvil thereby will maintain its structural integrity.

1. A tool kit for clinching, consisting of a punch (3.1) surrounded by an elastic stripper (3.2) operating along an axis (3.10) running through the center of a die cavity (3.5) the bottom of which is the free face of an anvil (3.6) and the sides of which consist of two or more moving die elements (3.7) and (3.8) which can slide laterally on a supporting surface (3.9) essentially perpendicular to said axis (3.10), said die elements (3.7) and (3.8) pressed against the sides of said anvil (3.6) through one or more spring elements (3.13) and thus forming a die with moving walls
characterized in that one or more guiding elements (3.11), running parallel to said supporting surface (3.9), through said die elements (3.7) and (3.8), said guiding element (3.11) having dimensions, cross section, surface finish and axial position which closely match holes (3.12) through said die elements (3.7) and (3.8) and thus make said die elements (3.7) and (3.8) slide on said supporting surface (3.9) without pivoting or rotating, said guiding element (3.11) being firmly connected to said anvil (3.6) and the length of which being roughly equal to or exceeding the distance between the outer faces of said die elements (3.7) and (3.8) when said die elements (3.7) and (3.8) are a maximum distance from said axis (3.10) and consequently serve in keeping said die elements (3.7) and (3.8) in place axially when said stripper (3.2) pulls out said punch (3.1) along said axis (3.10) when the clinching operation is finished

2. A tool kit for clinching according to claim 1
characterized in that the extremities of said guiding element (3.11) are held in a cage (4.1) connected to the non-moving parts of said die where the spring action (4.2) and (4.3) between said cage (4.1) and said die elements (3.7) and (3.8) replace said spring element (3.13)

3. A tool kit for clinching according to claim 2 characterized in that said cage (4.1) forms an integrated part of the solid side parts (7.5) and (7.6) of said die

4. Method for manufacturing of tool kit according to claim 3 characterized in that a blank for the non-moving parts of said die having essentially the shape of a parallelepiped (6.1) is machined in such a way that a through hole (6.2) is created parallel to the upper rectangular face (6.3) of said blank (6.1) and oriented along the longer dimension of said upper rectangular face (6.3), whereafter grooves (7.1) and (7.2) are created perpendicularly to said through hole (6.2) in such a way that said anvil (3.6), said supporting surface (3.9) and said solid side parts (7.5) and (7.6) of said die to the intended dimensions, whereafter said blank (6.1) is given its final, not necessarily parallelepipedic shape, whereafter selected parts such as said anvil (3.6) and said supporting surface (3.9) may be hardened, whereafter final assembly can take place, whereas said guiding element (3.11) is pushed in place from one said solid side part of the die (7.5), through said through hole (6.2), in such a way that said guiding element (3.11) runs though said spring element (4.2), said die element (3.7), said anvil (3.6), said die element (3.8), said spring element (4.3) and finally reaching said other solid side part of the die (7.6).

5. Method for manufacturing of tool kit according to claim 4
characterized in that said through hole (6.2) through said anvil (3.6) have such tolerances in relation to said guiding element (3.11) that a shrink fit is created between said guiding element (3.11) and said through hole (6.2) resulting in a locking of said guiding element (3.11) without added locking rings or similar
